(19) United States
(12) Patent Application Publication
(10) Pub. No.: US 2020/0224489 A1
(43) Pub. Date: Jul. 16, 2020

(54) Pet Door Apparatus

(71) Applicant: Katherine Joanne Chiodo, Thunder Bay (CA)

(72) Inventor: Katherine Joanne Chiodo, Thunder Bay (CA)

(21) Appl. No.: 16/245,193

(22) Filed: Jan. 10, 2019

(51) Int. Cl. E06B 7/32

(52) U.S. Cl. CPC E06B 7/32

(57) ABSTRACT

A pet access door that is adaptable for disposition within a door frame having two vertical door jambs and a horizontal door casing. The door includes a first panel and a second panel arranged in a parallel, substantially overlapping relationship to the first panel. The first and second panels are configured to move outwardly to an expanded engagement position in order to engage the pet access door against the two vertical door jambs of the door frame. A securing apparatus is configured to removably secure the first panel and second panel to the door frame. A pet access door assembly is mounted within the second panel and allows access therethrough when the first and second panels are in the expanded engagement position.

### REFERENCE TO PENDING APPLICATIONS

This application does not claim the benefit of any issued U.S. Patent or pending application.

### TECHNICAL FIELD

The present invention relates generally to a pet access door, and more particularly to pet access door for inclusion within a portable barrier of adjustable height width sufficient for insertion into a door frame.

### BACKGROUND

Pet access doors allow the passage of small pets through holes in doors or walls. Originally, they consisted principally of a frame mounted on the surface of the door or wall at the edges of a hole that had been cut, and a door hinged on the frame to keep the elements out but to allow passage of a small animal through the hole by its pushing against the hinged door.

Such prior art doors are usually permanently installed within a wall or door and are quite expensive due to the necessity of making extensive alterations to the wall or door in which they are installed.

Thus, there is a need for a pet door panel that can be removably installed within an existing door frame.

### SUMMARY

The present invention relates generally to a pet access door, and more particularly to pet access door for inclusion within a portable barrier of adjustable height width sufficient for insertion into a door frame.

In one aspect of the present invention, a pet access door adaptable for disposition within a door frame is disclosed. The pet access door includes a first panel and a second panel arranged in a parallel, substantially overlapping relationship to the first panel. The first panel and second panel are configured to move outwardly to an expanded engagement position to engage the pet access door against the two vertical door jambs of the door frame. A securing apparatus is configured to removably secure the first panel and second panel against the two door jambs. Within the second panel is a pet access door assembly that allows access therethrough when the first panel and second panel are in the expanded engagement position. In some aspects, the height of the first panel and second panel are substantially equal to the height of the door frame.

In another aspect of the present invention, the pet access door further includes a third panel and a fourth panel. These panels are arranged in a parallel, substantially overlapping relationship to top end of the first panel and second panels respectively. Securing apparatus are configured to removably secure the third and fourth panels to the horizontal door casing of the door frame.

Other aspects and features of the present invention will become apparent to those ordinarily skilled in the art upon review of the following description of specific embodiments of the invention in conjunction with the accompanying figures.

### BRIEF DESCRIPTION OF THE DRAWING

In drawings which illustrate embodiments of the invention wherein similar characters of reference denote corresponding parts in each view,

FIG. 1 is a front elevation view of an embodiment of the pet access door of the present invention;

FIG. 2 is a top view of an embodiment of the pet access door of the present invention in a closed position;

FIG. 3 is a top view of an embodiment of the pet access door of the present invention in an extended position;

FIG. 4 is a front close-up view of the pet access door assembly an according to an embodiment of the present invention;

FIG. 5 is a front elevation view of an additional embodiment of the pet access door of the present invention.

### DETAILED DESCRIPTION OF THE INVENTION

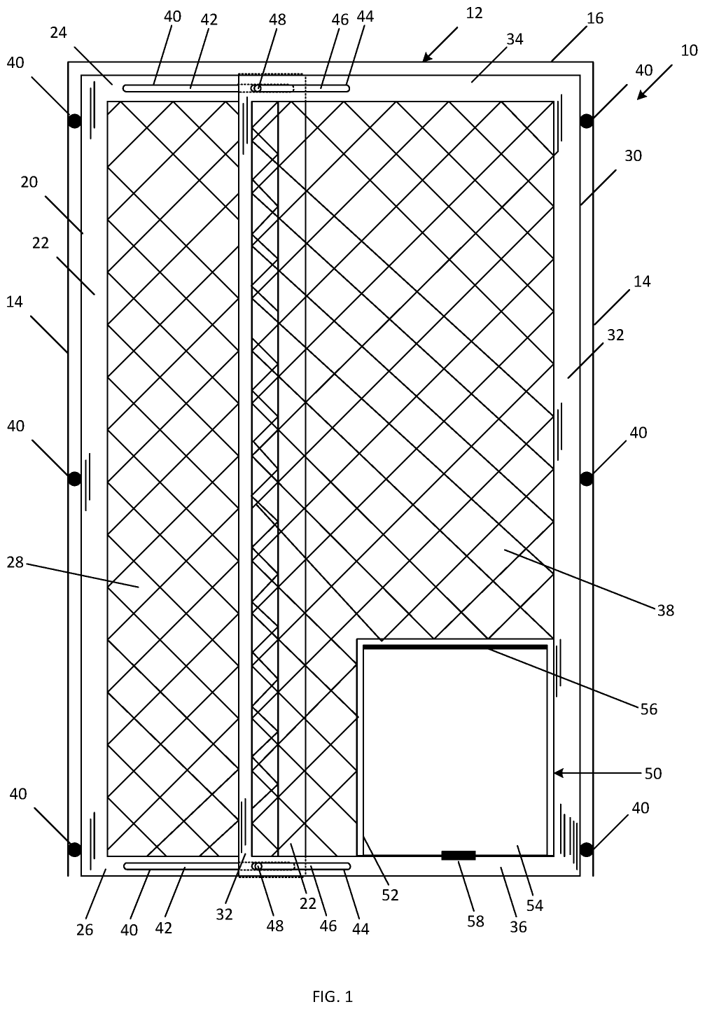

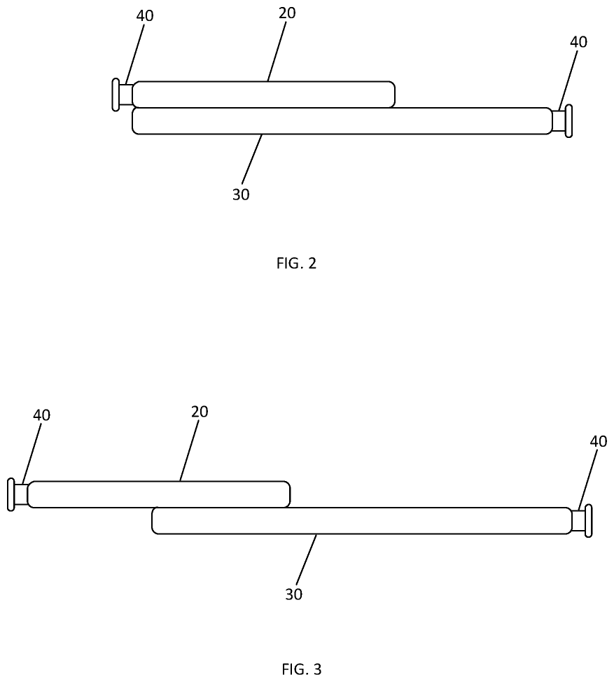

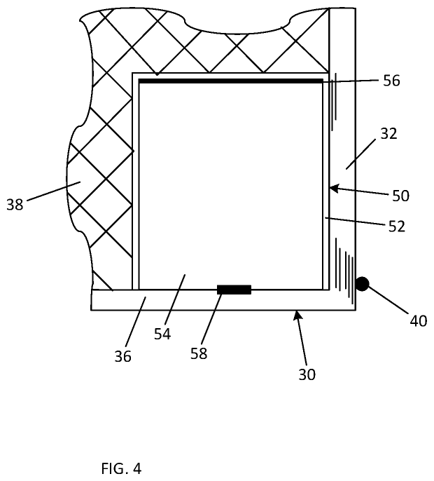

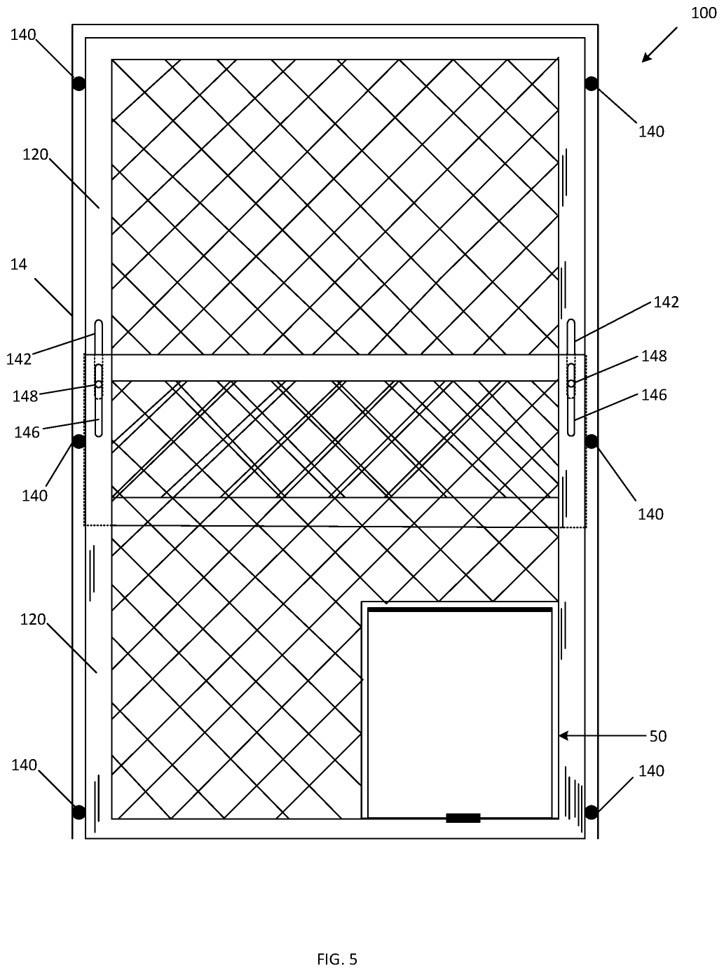

Referring to the FIGS. 1-4, an embodiment of a pet access door 10 is illustrated. Pet access door 10 placed within a door frame 12 to allow pets pass therethrough without the need of keeping the door open. This allows for pets to have the freedom of movement while keeping access through the doorway secure. In this embodiment, the pet access door 10 may be extended such that it comes into contact with the two vertical side jambs 14 and the top horizontal door casing 16 of the door frame 12.

Pet access door 10 may be a solid frame of wood, metal, plastic or vinyl. Door 10 includes a first panel 20 and a second panel 30 arranged in a parallel, substantially overlapping relationship to the first panel 30. Each panel 20, 30 have two vertical sides 22, 32, a top horizonal cross piece 24, 34 and a bottom horizontal cross piece 26, 36. Also, shown is a mesh grate 28, 38 in the middle of each panel 20, 30. While this embodiment utilizes a mesh grate 28, 38, this is merely illustrative. The middle of one or both panels 20, 30 may be solid, transparent or a combination thereof.

In this embodiment, panels 20, 30 are configured to slidably extend away and toward each other by way of panel slots 40, 44. Further, panels 20, 30 are configured to be lockably interconnected with one another by locking pins 48 disposed within panel slots openings 42, 46.

Each of the locking pins 48 have flanged head and an anchoring member having a greater diameter that the width dimension of the corresponding panel slots 40, 44, such that when tightened, the panels 20, 30 are prevented from being pulled apart and to allow them to be interlocked.

A securing apparatus 40 is configured to removably secure the first panel and second panel against the two door jambs. In this embodiment, securing apparatus 40 are engagement feet that are secured to outer vertical sides 22, 32 of each panel 20, 30. When panels 20, 30 are extended outward, away from each other, securing apparatus 40 comes into contact with the side jambs 14 thereby securing the panels 20, 30 to the door frame 12. When the panels 20, 30 are moved inward, toward each other, securing apparatus 40 disengages from the side jambs 14 allowing the pet access door to be removed from within the door frame 12.

In this embodiment, securing apparatus 40 are engagement feet. However, this is illustrative and not meant to be limiting. Those skilled in the art will recognized that other apparatus may be used to removable secure the pet access door 10 to a door frame 12. These other apparatus may include, but limited to, suction cups, telescoping extension bars with engagement ends, racketing apparatus affixed to one or both panels, etc.

Within second panel 30 is a pet access door assembly 50 that allows access therethrough when the first panel 20 and second panel 30 are in the expanded engagement position. In some aspects, the height of the first panel 20 and second panel 30 are substantially equal to the height of the door frame.

In this embodiment, pet access door assembly 50 includes a pet door frame 52, a pet door 54 which is connected to pet door frame 52 by way of a hinge 56. A magnet 58 is positioned at the bottom of pet door 54 to prevent unnecessary movement of pet door 54 when not in use by a pet. This pet door assembly 50 is merely illustrative and is not meant to be limiting. Those skilled in the art will recognized that many pet door designs may be included within the second panel 30.

Referring to the FIG. 5, an additional embodiment of a pet access door 100 is illustrated. Pet access door 100 is similar to the above described embodiment having two panels 120, 130 that are arranged in a parallel, substantially overlapping relationship.

In this embodiment, panels 120, 130 are configured to slidably extend away along a vertical axis such that in an extended engagement position, the height of the panels 120, 130 are substantially equal to the height of the door frame. Further, panels 120, 130 are configured to be lockably interconnected with one another by locking pins 148 disposed within panel slots openings 142, 146.

A securing apparatus 140 is configured to removably secure the first panel and second panel against the two door jambs.

Within second panel 130 is a pet access door assembly 150 that allows access therethrough when the first panel 120 and second panel 130 are in the expanded engagement position. In some aspects, the height of the first panel 20 and second panel 30 are substantially equal to the height of the door frame.

While the invention herein disclosed has been described by means of specific embodiments and applications thereof, numerous modifications and variations could be made thereto by those skilled in the art without departing from the scope of the invention set forth in the claims.

I claim:

1. A pet access door adaptable for disposition within a door frame having two vertical door jambs and a horizontal door casing, the assembly comprising:
a first panel;
a second panel arranged in a parallel, substantially overlapping relationship to the first panel, the first panel and second panel configured to move outwardly to an expanded engagement position to engage the pet access door against the two vertical door jambs of the door frame;
a securing apparatus configured to removably secure the first panel and second panel to the door frame; and
a pet access door assembly mounted within the second panel, the pet access door assembly allowing access therethrough when the first panel and second panel are in the expanded engagement position.

2. The pet access door of claim 1, wherein the height of the first panel and second panel are substantially equal to the height of the door frame.

3. The pet access door of claim 1, further comprising:
a third panel arranged in a parallel, substantially overlapping relationship to top end of the first panel;
a third panel securing apparatus configured to removably secure the third panel to the horizontal door casing;
a fourth panel arranged in a parallel, substantially overlapping relationship to top end of the second panel; and
a fourth panel securing apparatus configured to removably secure the fourth panel to the horizontal door casing.
